(19) United States
(12) Patent Application Publication
(10) Pub. No.: US 2018/0113370 A1
(43) Pub. Date: Apr. 26, 2018

(54) DISPLAY MODULE AND DISPLAY SYSTEM

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wenqing Zhao, Beijing (CN); Xue Dong, Beijing (CN); Xiaochuan Chen, Beijing (CN); Qian Wang, Beijing (CN); Jian Gao, Beijing (CN); Pengcheng Lu, Beijing (CN); Ming Yang, Beijing (CN); Rui Xu, Beijing (CN); Lei Wang, Beijing (CN); Xiaochen Niu, Beijing (CN)

(21) Appl. No.: 15/527,005

(22) PCT Filed: Jun. 20, 2016
(86) PCT No.: PCT/CN2016/086702

§ 371 Date: May 15, 2017

(30) Foreign Application Priority Data
Mar. 23, 2016 (CN) 201610169782.0

(51) Int. Cl. G02F 1/31; G06F 3/01; G09G 3/36

(52) U.S. Cl. CPC G02F 1/31; G02F 2201/121; G09G 3/3648; G06F 3/013

(57) ABSTRACT

Embodiments of the present disclosure provide a display module and a display system. The display module includes a flat display panel and a light adjustment structure provided at a light exit side of the flat display panel; the light adjustment structure is configured to adjust light emitted from the display panel to refract the light emitted from different positions of the flat display panel towards a position adjacent to a viewer's eye, thereby the position of the viewer's eye becomes an optimal angle of view position.

### CROSS-REFERENCE TO RELATED APPLICATION

This application is a Section 371 National Stage Application of International Application No. PCT/CN2016/086702, filed on 22 Jun., 2016, entitled “DISPLAY MODULE AND DISPLAY SYSTEM”, which has not yet published, and which claims priority to Chinese Application No. 201610169782.0, filed on 23 Mar., 2016, incorporated herein by reference in their entirety.

### BACKGROUND

### Technical Field

Embodiments of the present disclosure generally relate to the field of display technologies, and particularly, to a display module and a display system.

### Description of the Related Art

Existing display devices generally include a flat panel display device and a curved display device, where the flat panel display device has been widely applied due to its advantage of saving physical space when compared to the curved display device. Intensity distribution of light emitted from the flat panel display is shown in FIG. 1(a) and FIG. 1(b) (in FIG. 1(b), X axis represents a distance from a middle position of the display device to other positions, Y axis represents intensity of light), the intensity of light will gradually become weak from the middle position of the display device to two sides, which thus will not give a good visual experience to a viewer's eye, especially the intensity of light on two sides of a large-sized display device will be weaker.

The curved display device is a display device which is formed to have a certain radian, as shown in FIG. 2, such that different positions of the display device each directly face the viewer's eye, thereby the viewer may obtain an optimal visual experience. This curved design, however, can only provide comfort experience to the viewer at the middle position of the display device and cannot give consideration to other viewing positions, and the curved design will result in a larger physical volume occupied by the display device, thereby resulting in limited applications of the curved display device.

### SUMMARY

Embodiments of the present disclosure provide a display module and a display system, enabling a curved display effect, and solving the problem that the curved display device occupies a larger physical space.

According to an aspect of the present disclosure, there is provided a display module, including a display panel and a light adjustment structure provided at a light exit side of the display panel, the light adjustment structure is configured to adjust light emitted from the display panel to refract the light emitted from the display panel towards a position adjacent to a viewer's eye.

In one embodiment, the light adjustment structure is a liquid crystal panel; the liquid crystal panel includes a first substrate and a second substrate assembled, and a liquid crystal layer provided between the first substrate and the second substrate; and one of the first substrate and the second substrate is provided with a plurality of electrode sets each including a plurality of electrodes insulated from one another.

In one embodiment, the light adjustment structure further includes a common electrode provided on the other of the first substrate and the second substrate, and the common electrode and the electrode sets are configured to, when being applied with voltages, commonly drive liquid crystal molecules of the liquid crystal layer located therebetween to deflect such that portions of the liquid crystal layer corresponding to respective electrode sets present different refractive indexes so as to refract the light emitted from the display panel towards the position adjacent to the viewer's eye.

In one embodiment, deflection angles of the liquid crystal molecules in the liquid crystal layer are allowed to be controlled by the common electrode and the electrode sets such that liquid crystal layer becomes an equivalent optical component, which refracts the light emitted from the display panel towards the position adjacent to the viewer's eye.

In one embodiment, the equivalent optical component includes a lens and/or a prism. Further in one embodiment, each electrode set includes a plurality of stripe electrodes or a plurality of electrodes arranged in an array.

In one embodiment, each electrode set or each electrode is configured to be applied with a voltage independently.

In one embodiment, the display panel is a liquid crystal display panel or an organic electroluminescence light emitting diode display panel.

Further In one embodiment, when the display panel is a liquid crystal display panel, the display module further includes a color filter layer or prismatic layer; the color filter layer or prismatic layer is provided on the light adjustment structure, or the color filter layer or prismatic layer is provided on the liquid crystal display panel.

According to another aspect of the present disclosure, there is further provided a display system, including the above-described display module.

In one embodiment, the above-described display system further includes: a camera configured to trace the position of the viewer's eye; and a controller configured to control the light adjustment structure such that the light adjusted by the light adjustment structure is refracted towards the position adjacent to a viewer's eye in accordance with a change in the position of the viewer's eyes.

In one embodiment, the display system further includes a switch device connected with the light adjustment structure; and the switch device is configured to control whether or not the light emitted from the display panel is adjusted by the light adjustment structure, so as to enable switching between a flat panel display mode and a curved display mode.

### BRIEF DESCRIPTION OF THE DRAWINGS

In order to clearly describe technical schemes in embodiments of the present disclosure or in prior arts, accompanying drawings used for illustrating the embodiments or prior arts will be simply described. Obviously, the accompanying drawings described below merely refer to some of embodiments of the present disclosure, and those ordinary skilled in the art may arrive at other accompanying drawings based on these accompanying drawings without any creative efforts.

FIG. 1(a) is a schematic diagram showing a light intensity distribution of a flat panel display device in prior art;

FIG. 1(b) is a graph showing a light intensity distribution of a flat panel display device in prior art;

FIG. 2 is a schematic diagram showing a light intensity distribution of a curved display device in prior art;

FIG. 3 is a schematic diagram showing an overall structure of a display module according to an embodiment of the present disclosure;

FIG. 4 is a cross sectional view schematically showing a structure of a display module according to an embodiment of the present disclosure;

FIG. 5 is a schematic diagram showing light adjustment principle of a light adjustment structure according to an embodiment of the present disclosure;

FIG. 6(a) is a structural schematic diagram of an equivalent prism formed by liquid crystal according to an embodiment of the present disclosure;

FIG. 6(b) is a structural schematic diagram of an equivalent prism formed by liquid crystal according to another embodiment of the present disclosure;

FIG. 7(a) is a structural schematic diagram of an equivalent lens formed by liquid crystal according to a further embodiment of the present disclosure;

FIG. 7(b) is a structural schematic diagram of an equivalent lens formed by liquid crystal according to a still further embodiment of the present disclosure;

FIG. 8(a) is a schematic diagram showing arrangement of stripe electrodes of an electrode set according to an embodiment of the present disclosure;

FIG. 8(b) is a schematic diagram showing arrangement of stripe electrodes of an electrode set according to another embodiment of the present disclosure;

FIG. 8(c) is a schematic diagram showing arrangement of electrodes of an electrode set arranged in an array according to a further embodiment of the present disclosure;

FIG. 8(d) is a schematic diagram showing arrangement of electrodes of an electrode set arranged in an array according to a still further embodiment of the present disclosure;

FIG. 9(a) is a structural schematic diagram of a display module according to another embodiment of the present disclosure;

FIG. 9(b) is a structural schematic diagram of a display module according to a further embodiment of the present disclosure; and

FIG. 10 is a block diagram schematically showing arrangement of a display system according to an embodiment of the present disclosure.

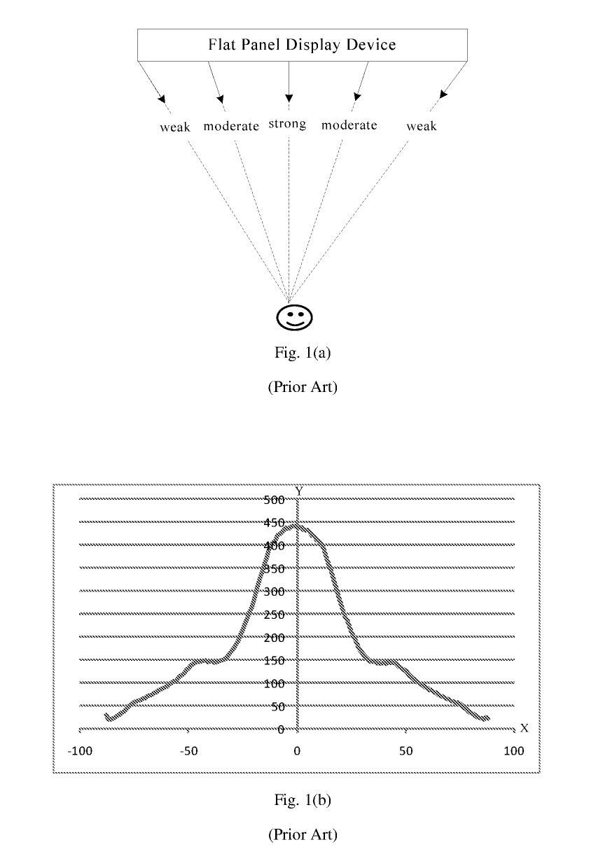

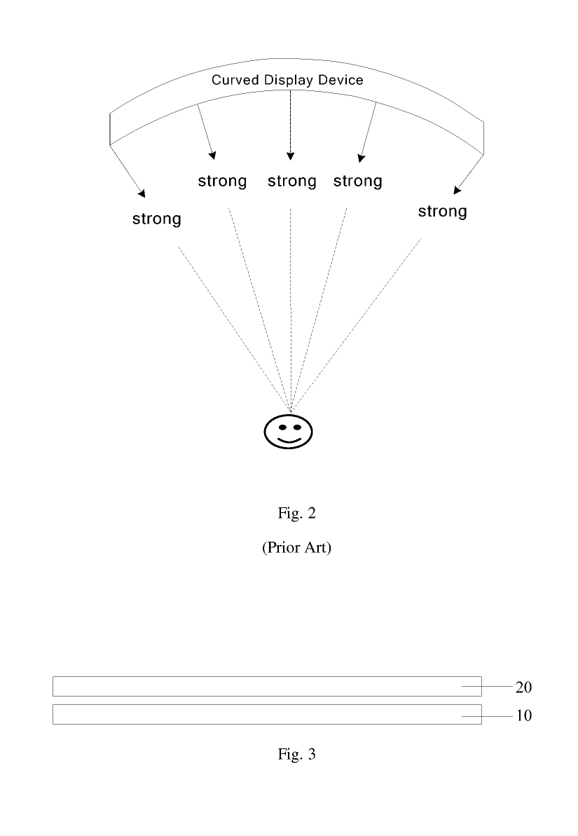

### DETAILED DESCRIPTION OF PREFERRED EMBODIMENTS

A clear and complete description of the technical schemes according to embodiments of the present disclosure will be made below with reference to the accompanying drawings. Obviously, the embodiments described are merely parts, instead of all, of embodiments of the present disclosure. Any embodiment that is obtained based on the embodiments of the present disclosure by those skilled in the art without any creative efforts will fall within protection scopes of the present disclosure.

An embodiment of the present disclosure provides a display module, as shown in FIG. 3, including a display panel 10 and a light adjustment structure 20 provided at a light exit side of the display panel 10.

The light adjustment structure 20 is configured to adjust light emitted from the display panel 10 to refract the light emitted from the display panel 10 towards a position adjacent to a viewer's eye.

Herein, the light adjustment structure 20 is particularly configured to adjust light emitted from the display panel 10 to refract the light emitted from the display panel 10 towards a position adjacent to the viewer's eye.

It is noted that “to refract the light emitted from the display panel 10 towards a position adjacent to the viewer's eye” means that the direction of the light emitted from the display panel 10 may be adjusted by the adjustment structure 20 to be refracted towards the viewer's eye, and it is not limited that the light is only refracted towards the viewer's eye, rather, the light may be refracted towards a position around the viewer's eye.

Herein, fixing connection between the light adjustment structure 20 and the display panel 10 is not limited, and for example, OCA (Optically Clear Adhesive) may be used to fix the light adjustment structure 20 and the display panel 10 (the OCA is not shown in FIG. 3).

In the display module according to embodiments of the present disclosure, since the light adjustment structure can adjust the light emitted from the display panel to be refracted towards a position adjacent to a viewer's eye, such that all light emitted from different positions of the display panel may be refracted towards the position of the viewer's eye, thereby a curved display effect may be achieved, and further, such that the position of the viewer's eye is an optimal angle of view position, thereby avoiding the problem that the intensity of light will gradually become weak from the middle position of the existing flat panel display device to two side positions thereof, and avoiding the problem that only the middle position of the existing curved display panel is the optimal angle of view position. Further, since the display module in embodiments of the present disclosure is a flat display module which enables a curved display effect in an optical way, thus the problem that the curved display device occupies a larger physical space is also solved.

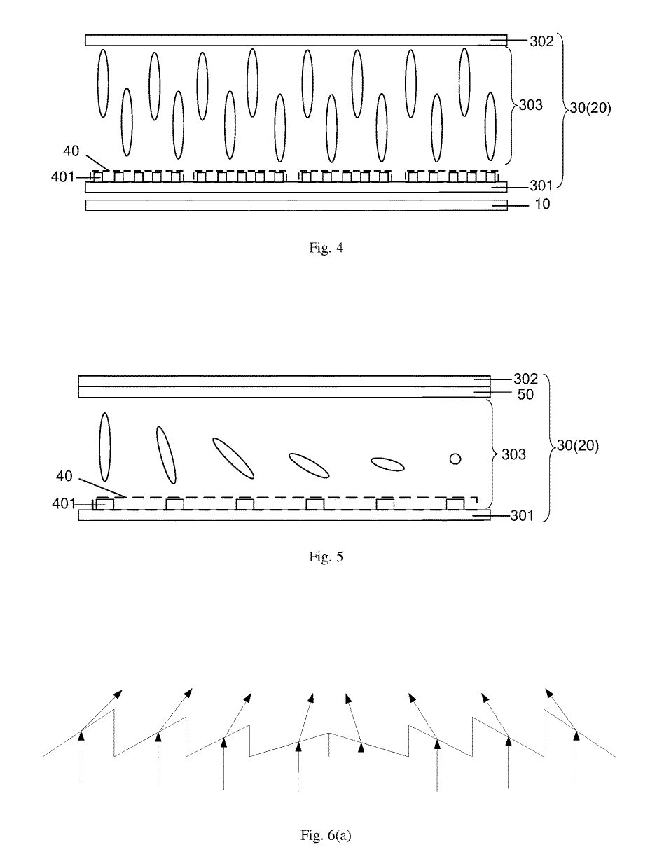

In one embodiment, as shown in FIG. 4 and FIG. 5, the light adjustment structure 20 is a liquid crystal panel 30. The liquid crystal panel 30 includes a first substrate 301 and a second substrate 302 assembled, and a liquid crystal layer 303 provided between the first substrate 301 and the second substrate 302.

One of the first substrate 301 and the second substrate 302 is provided thereon with a plurality of electrode sets 40. Each of the plurality of electrode sets 40 includes a plurality of electrodes 401 insulated from one another.

It will be understood by those skilled in the art that in order to drive liquid crystal molecules of the liquid crystal layer 303 to deflect, the above-described liquid crystal display module further includes a common electrode 50, and the common electrode 50 and the electrode sets 40 may be arranged on different substrates so as to commonly drive the liquid crystal molecules to deflect. For example, the electrode sets 40 are provided on the first substrate 301, while the common electrode 50 is provided on the second substrate 302; or, the electrode sets 40 are provided on the second substrate 302, while the common electrode 50 is provided on the first substrate 301. In an example, the common electrode 50 may be configured in a planar or plate shape. Embodiments of the present disclosure will be illustratively described by taking the common electrode 50 provided on the second substrate 302 as an example.

The principle by which the direction of the light emitted from the liquid crystal panel 30 is adjusted in embodiments of the present disclosure will be described as follows: as shown in FIG. 5, when a voltage applied to the common electrode 50 is constant or not changed, deflection states of liquid crystal molecules at positions corresponding to the electrode sets 40 may be controlled to be changed by controlling voltages applied to the electrodes 401 of the electrode sets 40 to vary, such that portions of the liquid crystal layer located at positions corresponding to respective electrode sets 40 present different refractive indexes so as to refract the light emitted from the display panel 10 towards a position adjacent to a viewer's eye. When the liquid crystal panel 30 is controlled to refract the light emitted from the display panel 10 towards the position adjacent to the viewer's eye, the position of the viewer's eye is an optimal angle of view position.

On basis of the above description, in embodiments of the present disclosure, deflection states of liquid crystal molecules of the liquid crystal panel 30 are controlled, such that the light emitted from the display panel 10 may be adjusted to be refracted towards the position adjacent to the viewer's eye; at this time, the liquid crystal layer of the liquid crystal panel 30 functions as an optical component, thus the liquid crystal layer is actually equivalent to the optical component. In an example, the equivalent optical component may be for example a prism or lens.

Herein, the liquid crystal layer of the liquid crystal panel 30 may be formed into equivalent optical components in various forms by controlling voltages applied to the electrode 401 of the electrode sets 40.

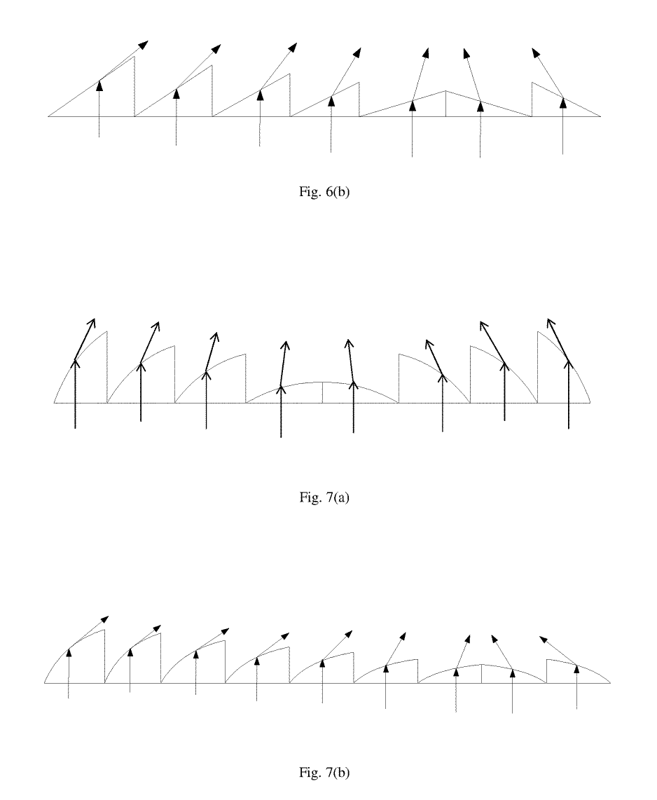

Exemplarily, by controlling voltages applied to the electrode 401 of the electrode sets 40, portions of the liquid crystal layer located at positions corresponding to respective electrode sets 40 may be equivalent to forms of prism shown in FIG. 6(a) and FIG. 6(b), for example. When the voltages applied to the electrode 401 of the electrode sets 40 is controlled such that the liquid crystal layer is formed into an equivalent prism shown in FIG. 6(a), all light emitted from the display panel 10 will be refracted towards a middle position, which thus is an optimal angle of view position. When the voltages applied to the electrode 401 of the electrode sets 40 is controlled such that the liquid crystal layer is formed into an equivalent prism shown in FIG. 6(b), all light emitted from the display panel 10 will be refracted towards a right position, which is thus an optimal angle of view position.

Of course, by controlling the voltages applied to the electrode 401 of the electrode sets 40, the portions of the liquid crystal layer located at positions corresponding to respective electrode sets 40 may be equivalent to forms of lens shown in FIG. 7(a) or FIG. 7(b), for example. When the voltages applied to the electrode 401 of the electrode sets 40 is controlled such that the liquid crystal layer is formed into an equivalent lens shown in FIG. 7(a), all light emitted from the display panel 10 will be refracted towards a middle position, which thus is an optimal angle of view position.

When the voltages applied to the electrode 401 of the electrode sets 40 is controlled such that the liquid crystal layer is formed into an equivalent prism shown in FIG. 7(b), all light emitted from the display panel 10 will be refracted towards a right position, which is thus an optimal angle of view position.

Herein, the equivalent optical components, which are formed by the liquid crystal layer by controlling the voltages applied to the electrode 401 of the electrode sets 40, are neither limited to the prism shown in FIG. 6(a) or FIG. 6(b), nor limited to the lens shown in FIG. 7(a) or FIG. 7(b), and may include other optical components.

It is noted that the number of the electrodes 401 of each the electrode set 40 is appropriately set according to dimensions of the electrodes 401.

In an example, voltages applied to respective electrodes 401 may be controlled independently; particularly, the voltages applied to respective electrodes 401 of the electrode sets 40 may be controlled according to the position of the viewer's eye.

Shapes of electrodes 401 of the electrode sets 40 are not limited herein.

In embodiments of the present disclosure, since the liquid crystal panel 30 is provided thereon with a plurality of the electrode sets 40 each including a plurality of electrodes 401 insulated from one another, deflection angles of liquid crystal molecules may be controlled by controlling voltages applied to the electrodes 401 of the electrode sets 40, such that equivalent refractive indexes of portions of liquid crystal layer 303 located at positions corresponding to respective electrode sets 40 vary, thereby the light emitted from the display panel 10 is adjusted to be refracted towards a position adjacent to the viewer's eye.

In one embodiment, the electrode set 40 includes a plurality of stripe electrodes 401 or a plurality of electrodes 401 arranged in an array.

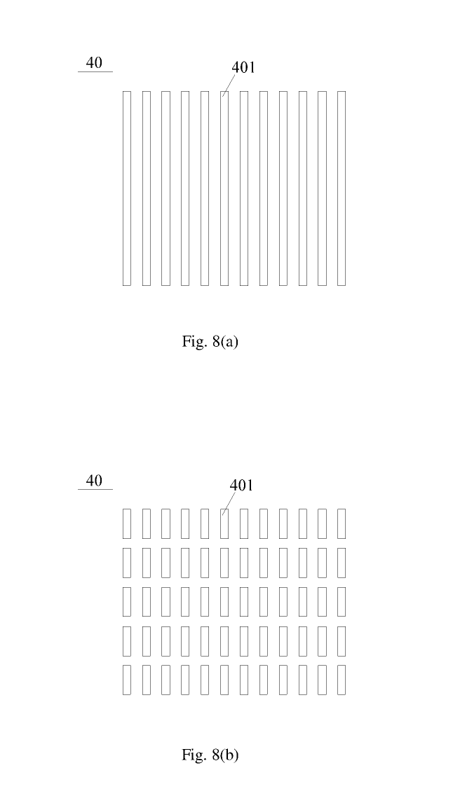

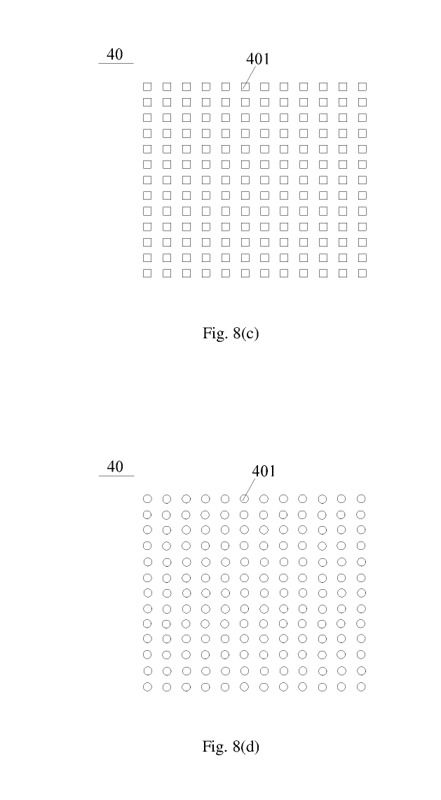

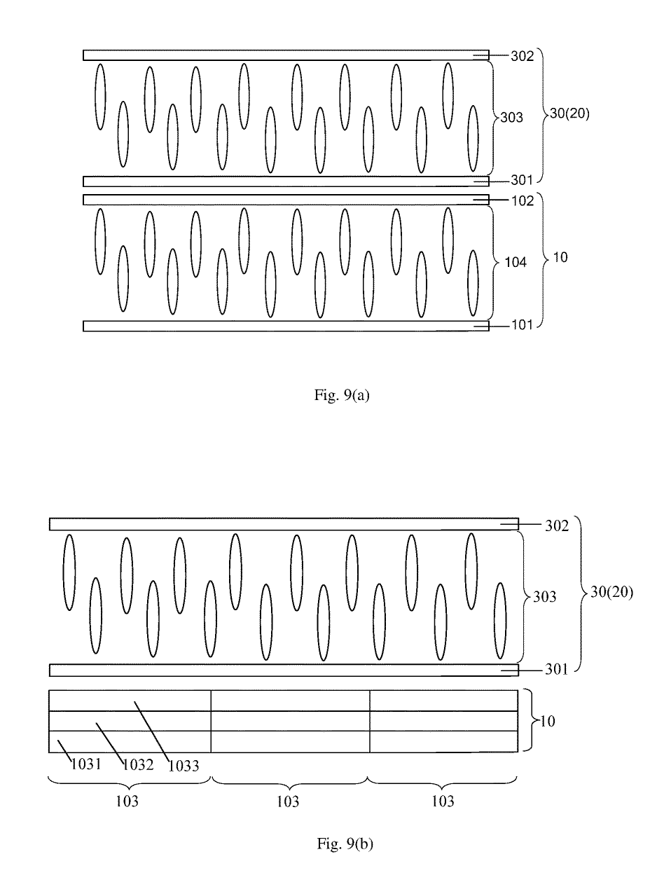

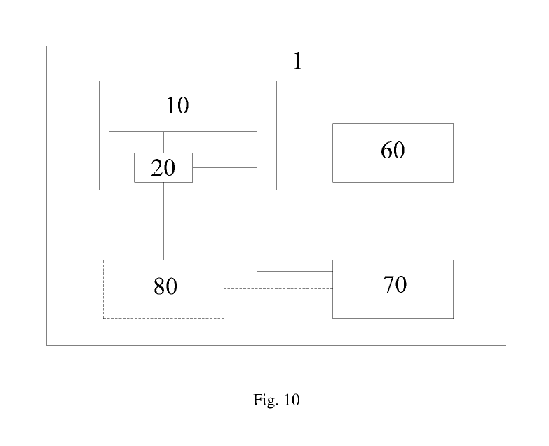

In an example, the stripe electrodes may include, for example, stripe electrodes 401 arranged consecutively as shown in FIG. 8(a), or stripe electrode 401 arranged inconsecutively as shown in FIG. 8(b). The plurality of electrodes 401 arranged in an array may include, for example, an array of stripes electrodes shown in FIG. 8(b), an array of square electrodes shown in FIG. 8(c), or an array of circular electrodes shown in FIG. 8(d).

In one embodiment, the display panel 10 is a liquid crystal display panel or an organic electroluminescence light emitting diode display panel.

Illustratively, as shown in FIG. 9(a), when the display panel 10 is a liquid crystal display panel, the liquid crystal display panel includes an array substrate 101, an opposite substrate 102, and a liquid crystal layer 104 located between the array substrate 101 and the opposite substrate 102.

In an example, each sub-pixel of array substrate 101 includes a thin film transistor and a pixel electrode electrically connected with a drain of the thin film transistor; and a common electrode may be arranged on the array substrate 101 or on the opposite substrate 102.

As shown in FIG. 9(b), when the display panel 10 is an organic electroluminescence light emitting diode display panel, each sub-pixel 103 of the organic electroluminescence light emitting diode display panel may include an anode 1031, an organic material functional layer 1032 and a cathode 1033. In an example, the organic material functional layer 1032 at least includes a light emitting layer.

On basis of the above, each sub-pixel 103 may further include a thin film transistor having a drain electrically connected with the anode 1031.

In one embodiment, in order to achieve color display, the display module further includes a color filter layer or prismatic layer when the display panel 10 is a liquid crystal display panel; in an example, the color filter layer or prismatic layer is provided on the light adjustment structure 20, or the color filter layer or prismatic layer is provided on the liquid crystal display panel.

Herein, positions of the color filter layer and the prismatic layer are not limited, as long as color display can be achieved.

Herein, the prismatic layer may divide white light passing therethrough into light with different colors, thereby achieving color display.

It is noted that no matter the color filter layer is provided on the light adjustment structure 20 or on the display panel 10, color resistors of the color filter layer correspond to sub-pixels of the display panel 10 in a one-to-one correspondence.

An embodiment of the present disclosure further provides a display system 1, including the display module as described above.

Since the display system of embodiments of the present disclosure includes the display module as described above, all light emitted from different positions of the display panel 10 may be refracted towards positions adjacent to the viewer's eye, thereby the position of the viewer's eye is an optimal angle of view position.

In one embodiment, the above-described display system further includes a camera 60 and a controller 70; the camera 60 is configured to trace the position of the viewer's eye; and the controller 70 is configured to control the light adjustment structure 20 such that the light adjusted by the light adjustment structure is refracted towards the position adjacent to the viewer's eye in accordance with a change in the position of the viewer's eye.

The camera and the controller are provided in embodiments of the present disclosure, thus when the position of the viewer's eye is traced by the camera, the light emitted from the display panel 10 may be controlled by the controller such that it is emitted towards the position of the viewer's eye traced by the camera after being adjusted by the light adjustment structure 20, thereby no matter the position of the viewer's eye is located at a middle position or at either side position of the display system, the position of the viewer's eye is always an optimal angle of view position.

In one embodiment, the above-described display system 1 further includes a switch device 80 connected with the light adjustment structure 20; and the switch device 80 is configured to control whether or not the light emitted from the display panel 10 is adjusted by the light adjustment structure 20, so as to enable switching between a flat panel display mode and a curved display mode.

In an example, the switch device 80 is configured to control whether or not the light emitted from the display panel 10 is adjusted by the light adjustment structure 20 according to requirements from a user. When the light adjustment structure 20 is controlled by the switch device to adjust the light emitted from the display panel 10, that is, in the curved display mode, the light emitted from different positions of the display panel 10 is adjusted to be refracted towards a position adjacent to a viewer's eye by light adjustment structure 20, thereby enabling a curved display effect. When the adjustment structure 20 is controlled by the switch device to not adjust the light emitted from the display panel 10, that is, in the flat panel display mode, the light emitted from the display panel 10 will not be affected by the light adjustment structure 20, now the display panel 10 is equivalent to a normal flat display panel, thereby enabling a flat panel display effect.

In embodiments of the present disclosure, the light adjustment structure 20 is controlled to whether or not adjust the light emitted from the display panel 10 according to requirements from users, thereby satisfying various requirements from users. In other embodiments, the switch device 80 may be controlled by the controller, so that the flat panel display mode and the curved display mode of the display module can be automatically switched according to the position of the viewer's eye determined by the camera 60.

In the display module and the display system according to embodiments of the present disclosure, since the light adjustment structure can adjust the light emitted from the display panel to be refracted towards a position adjacent to a viewer's eye, such that all light emitted from different positions of the display panel may be refracted towards the position of the viewer's eye, thereby a curved display effect may be achieved, and further, such that the position of the viewer's eye is an optimal angle of view position, thereby avoiding the problem that the intensity of light will gradually become weak from the middle position of the existing flat panel display device to two side positions thereof, and avoiding the problem that only the middle position of the existing curved display panel is the optimal angle of view position. Further, since the display module in embodiments of the present disclosure is a flat display module which enables a curved display effect in an optical way, thus the problem that the curved display device occupies a larger physical space is solved.

The above description is merely exemplary embodiments of the present disclosure, and the present disclosure is not limited to this. Modifications or alternatives made within the spirit and principle of the present disclosure by those skilled in the art shall be included in the scopes of the present invention. Thus, the scopes of the present invention should be defined by the claims.

1. A display module, comprising a flat display panel and a light adjustment structure provided at a light exit side of the flat display panel;
wherein the light adjustment structure is configured to adjust light emitted from the flat display panel to refract the light emitted from different positions of the display panel towards a position adjacent to a viewer's eye so as to achieve a curved display.

2. The display module according to claim 1, wherein:
the light adjustment structure is a liquid crystal panel;
the liquid crystal panel comprises a first substrate and a second substrate assembled, and a liquid crystal layer provided between the first substrate and the second substrate; and
one of the first substrate and the second substrate is provided with a plurality of electrode sets each comprising a plurality of electrodes insulated from one another.

3. The display module according to claim 2, wherein:
the light adjustment structure further comprises a common electrode provided on the other of the first substrate and the second substrate, and
the common electrode and the electrode sets are configured to, when being applied with voltages, commonly drive liquid crystal molecules of the liquid crystal layer located therebetween to deflect such that portions of the liquid crystal layer corresponding to respective electrode sets present different refractive indexes so as to refract the light emitted from different positions of the flat display panel towards the position adjacent to the viewer's eye.

4. The display module according to claim 3, wherein deflection angles of the liquid crystal molecules in the liquid crystal layer are allowed to be controlled by the common electrode and the electrode sets such that the liquid crystal layer becomes an equivalent optical component, which refracts the light emitted from different positions of the flat display panel towards the position adjacent to the viewer's eye.

5. The display module according to claim 4, wherein the equivalent optical component comprises at least one of a lens and a prism.

6. The display module according to claim 2, wherein each electrode set comprises a plurality of stripe electrodes or a plurality of electrodes arranged in an array.

7. The display module according to claim 6, wherein each electrode set or each electrode is configured to be applied with a voltage independently.

8. The display module according to claim 1, wherein the flat display panel is a liquid crystal display panel or an organic electroluminescence light emitting diode display panel.

9. The display module according to claim 8, wherein when the flat display panel is a liquid crystal display panel, the display module further comprises a color filter layer or prismatic layer; and
wherein, the color filter layer or prismatic layer is provided on the light adjustment structure, or the color filter layer or prismatic layer is provided on the liquid crystal display panel.

10. A display system, comprising the display module of claim 1.

11. The display system according to claim 10, further comprising:
a camera configured to trace a position of the viewer's eye; and
a controller configured to control the light adjustment structure such that the light adjusted by the light adjustment structure is refracted towards the position adjacent to the viewer's eye in accordance with a change in the position of the viewer's eye.

12. The display system according to claim 10, wherein the display system further comprises a switch device connected with the light adjustment structure; and
the switch device is configured to control whether or not the light emitted from the flat display panel is adjusted by the light adjustment structure, so as to enable switching between a flat panel display mode and a curved display mode.

13. The display system according to claim 11, wherein the display system further comprises a switch device connected with the light adjustment structure; and
the switch device is configured to control whether or not the light emitted from the flat display panel is adjusted by the light adjustment structure, so as to enable switching between a flat panel display mode and a curved display mode.

14. The display system according to claim 10, wherein the light adjustment structure is a liquid crystal panel;
the liquid crystal panel comprises a first substrate and a second substrate assembled, and a liquid crystal layer provided between the first substrate and the second substrate;
one of the first substrate and the second substrate is provided with a plurality of electrode sets each comprising a plurality of electrodes insulated from one another; and
the light adjustment structure further comprises a common electrode provided on the other of the first substrate and the second substrate, and the common electrode and the electrode sets are configured to, when being applied with voltages, commonly drive liquid crystal molecules of the liquid crystal layer located therebetween to deflect such that portions of the liquid crystal layer corresponding to respective electrode sets present different refractive indexes so as to refract the light emitted from different positions of the flat display panel towards the position adjacent to the viewer's eye.

15. The display system according to claim 14, wherein deflection angles of the liquid crystal molecules in the liquid crystal layer are allowed to be controlled by the common electrode and the electrode sets such that liquid crystal layer becomes an equivalent optical component, which refracts the light emitted from different positions of the flat display panel towards the position adjacent to the viewer's eye.

16. The display system according to claim 15, wherein the equivalent optical component comprises at least one of a lens and a prism.

17. The display system according to claim 14, further comprising:
a camera configured to trace a position of the viewer's eye; and
a controller configured to control the light adjustment structure such that the light adjusted by the light adjustment structure is refracted towards the position adjacent to the viewer's eye in accordance with a change in the position of the viewer's eye.

18. The display system according to claim 17, wherein the display system further comprises a switch device connected with the light adjustment structure; and
the switch device is configured to control whether or not the light emitted from the flat display panel is adjusted by the light adjustment structure, so as to enable switching between a flat panel display mode and a curved display mode.

19. The display system according to claim 15, further comprising:
a camera configured to trace a position of the viewer's eye; and
a controller configured to control the light adjustment structure such that the light adjusted by the light adjustment structure is refracted towards the position adjacent to the viewer's eye in accordance with a change in the position of the viewer's eye.

20. The display system according to claim 19, wherein the display system further comprises a switch device connected with the light adjustment structure; and
the switch device is configured to control whether or not the light emitted from the flat display panel is adjusted by the light adjustment structure, so as to enable switching between a flat panel display mode and a curved display mode.
